(19) United States
(12) Patent Application Publication
(10) Pub. No.: US 2003/0106576 A1
(43) Pub. Date: Jun. 12, 2003

(54) Mobility appliance

(76) Inventors: Vernon R. Tunnell, JR., Portland, OR (US); Kimberly D. Tunnell, Portland, OR (US)

Correspondence Address: Keith A. Cushing, 4201 S. W. Vacuna St., Portland, OR, 97219, US

(21) Appl. No.: 10/314,050

(22) Filed: Dec. 6, 2002

Related U.S. Application Data
(60) Provisional application No. 60/340,293, filed on Dec. 7, 2001.

(51) Int. Cl. A61H 3/02

(52) U.S. Cl. 135/68

(57) ABSTRACT

A mobility appliance includes a support structure having a proximal end and a distal end, the distal end carrying a ground-contacting peg and includes a weight-bearing body contact element, the body contact element rotating about a pivot axis at the proximal end.

### RELATED APPLICATION

The present application relies for priority on prior-filed co-pending Provisional Application Serial No. 60/340,293 entitled Pivoting Body Form Crutch Head and filed Dec. 7, 2001 by applicants and inventors named herein.

### BACKGROUND OF THE INVENTION

A mobility appliance aids the injured or disabled in gaining or improving mobility. Many such appliances bear against the body and present opportunity for discomfort in use thereof. Padding or soft pliant materials ameliorate discomfort, but not entirely as significant discomfort typically remains, especially through prolonged use. Persons suffering to the extent that a mobility appliance is needed find great utility in an appliance presenting less opportunity for discomfort.

A crutch is a mobility appliance including at one end a base or ground-contacting peg and at the other end a body contacting head. Along the length of the crutch, a handgrip assumes a generally horizontal orientation with the crutch along a generally vertical orientation. In use, a person aligns the crutch vertically and generally along a selected body side and grasps the handle grip with the hand of the selected body side. With the upper portion of the crutch between the arm of the selected body side and the selected body side, the body contacting head lies at or near the underarm of the selected body side. Various adjustments, e.g., a distance between the handle grip and the peg and a distance between the handle grip and the head, better match crutch dimensions with body dimensions.

Body weight transferred at the handgrip and at the head aid in mobility. For example, when a crutch carries body weight otherwise carried by a disabled or inured limb the crutch improves mobility. Thus, body weight transfer into a mobility appliance often serves a fundamental function in aiding mobility.

Unfortunately, body weight transfer also causes discomfort at the area of body-appliance contact. In the case of a crutch appliance, significant discomfort arises at the under arm where the crutch head engages the body and supports body weight thereat. A crutch mobility appliance generally not only carries body weight, but constantly moves in relation to the user's body when the user moves, e.g., the crutch appliance moves relative to the person's body as the person walks along. As the person using the crutch moves, e.g., walks along, the head rubs against the under arm. Relative movement in conjunction with transfer of body weight presents discomfort. Prolonged use of the crutch translates into prolonged discomfort for the user.

It would be desirable, therefore, to provide improved comfort for persons using a mobility appliance.

### SUMMARY OF THE INVENTION

A mobility appliance includes a support structure having a proximal end and a distal end, the distal end carrying a ground-contacting peg and includes a weight-bearing body contact element, the body contact element rotating about a pivot axis at the proximal end.

The subject matter of the present invention is particularly pointed out and distinctly claimed in the concluding portion of this specification. However, both the organization and method of operation of various embodiments of the invention, together with further advantages and objects thereof, may best be understood by reference to the following description taken with the accompanying drawings wherein like reference characters refer to like elements.

### BRIEF DESCRIPTION OF THE DRAWINGS

For a better understanding of various embodiments of the invention, and to show how the same may be carried into effect, reference will now be made, by way of example, to the accompanying drawings in which:

FIG. 1 illustrates schematically a first embodiment according the present invention including a mobility apparatus having a pivotable body-contacting element.

FIG. 2 illustrates schematically the embodiment of FIG. 1 at a given orientation during use.

FIG. 3 illustrates schematically the embodiment of FIG. 1 at another given orientation during use.

FIG. 4 illustrates schematically a second embodiment of the present invention including also a pivotable body-contacting element and application of selected biasing forces thereto.

FIG. 5 illustrates partially and in exploded assembly view a third embodiment according to the present invention including a mobility appliance having a pivotable body-contacting and weight-bearing element.

FIG. 6 illustrates the embodiment of FIG. 5 partially and in assembled condition.

FIG. 7 illustrates a pivotable head of the embodiment of FIGS. 5 and 6.

FIG. 8 also illustrates the pivotable head of FIGS. 5 and 6 from an opposite view relative to that of FIG. 7.

FIG. 9 illustrates partially and in exploded assembly view a fourth embodiment of the present invention illustrating a mobility apparatus including a pivotable body-contacting, weight-bearing element, and coupling of biasing elements thereto.

FIG. 10 illustrates partially and in section the embodiment of FIG. 10 during assembly thereof.

FIG. 11 further illustrates assembly steps relative to the embodiment of FIG. 9.

FIG. 12 illustrates partially the embodiment of FIG. 9 in its assembled condition.

FIG. 13 illustrates separately a pivotable head of the embodiment of FIG. 9.

FIG. 14 illustrates the embodiment of FIG. 9 including the pivotable head from a view opposite that of FIG. 13.

FIGS. 15 and 16 illustrate in perspective one form of crutch head according to an embodiment of the present invention.

FIGS. 17, 18, 19, and 20 are right, left, front, and rear views, respectively, of the crutch head of FIGS. 15 and 16.

### DETAILED DESCRIPTION OF THE PREFERRED EMBODIMENT

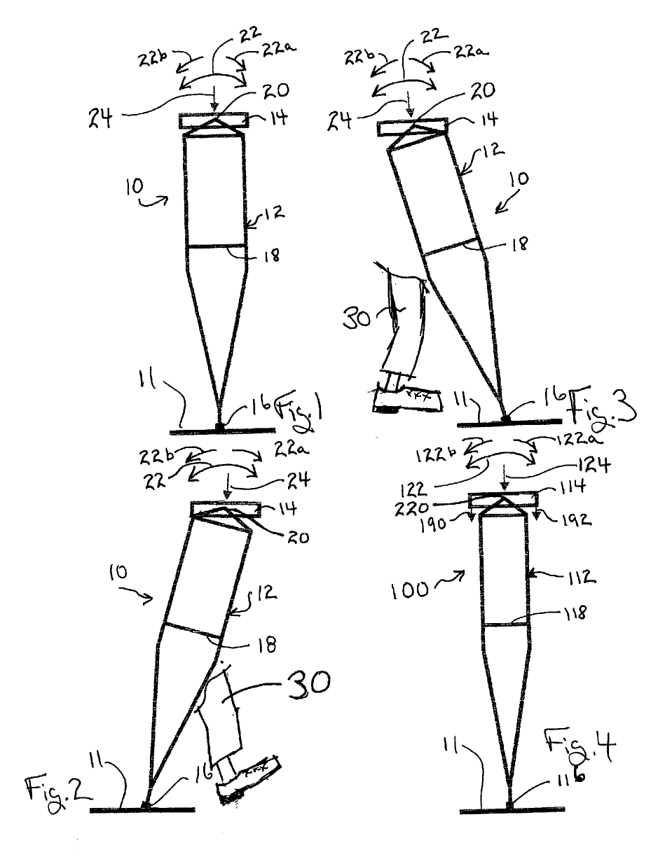

FIGS. 1-3 illustrate a first embodiment of the present invention. A mobility apparatus 10 providing a crutch structure and function. In FIGS. 1-3, apparatus 10 includes a frame 12 having at a lower end a ground-contacting point or peg 16. Frame 12 can be a generally simple rigid or static structure. In use, a ground-contacting point or peg, e.g., peg 16, acts as a simple pivot point relative to the ground surface 11. In other words, peg 16 bears against and pivots in contact with a ground surface 11 while transferring body weight in aid of mobility. Generally, peg 16 remains stationary relative to frame 12 and serves as a reliable and simple ground pivot and frame-to-ground surface 11 weight transfer mechanism. Similar frame and peg arrangements can be used in relation to a ground surface 11 in various embodiments of the present invention, including those embodiments illustrated herein.

At an upper end of frame 12, appliance 10 includes a head 14. A handgrip 18 lies along a mid-portion of frame 12 intermediate head 14 and peg 16. While not specifically illustrated in FIG. 1, it will be understood that appliance 10 may include certain length and position adjustment features. For example, handgrip 18 may be selectively positioned along the length of frame 12 to correspond to a user's underarm-to-hand dimension. Also, the relative distance between peg 16 and head 14 may be adjusted to correlate to a user's underarm-to-ground dimension. Similar handgrip and length and position adjustment features can be used in various embodiments of the present invention, including those embodiments illustrated herein.

Head 14 pivotally mounts relative to an upper portion of frame 12. More particularly, a pivot axis 20, located at the proximal or upper end of frame 12 and laterally disposed, permits pivoting or rotational movement of head 14 thereabout as indicated generally at reference numeral 22.

As appliance 10 moves in relation to a user relying thereon, appliance 10 moves between a forward position and a rearward position relative to, for example, a user leg 30. In some instances, frame 12 may move along with a user leg 30, but move relative to other portions of a user's body. Generally, in use frame 12 moves in various ways relative to various portions of a user's body. Thus, people make use of a crutch appliance in different ways, but generally move frame 12 in some fashion relative to their body.

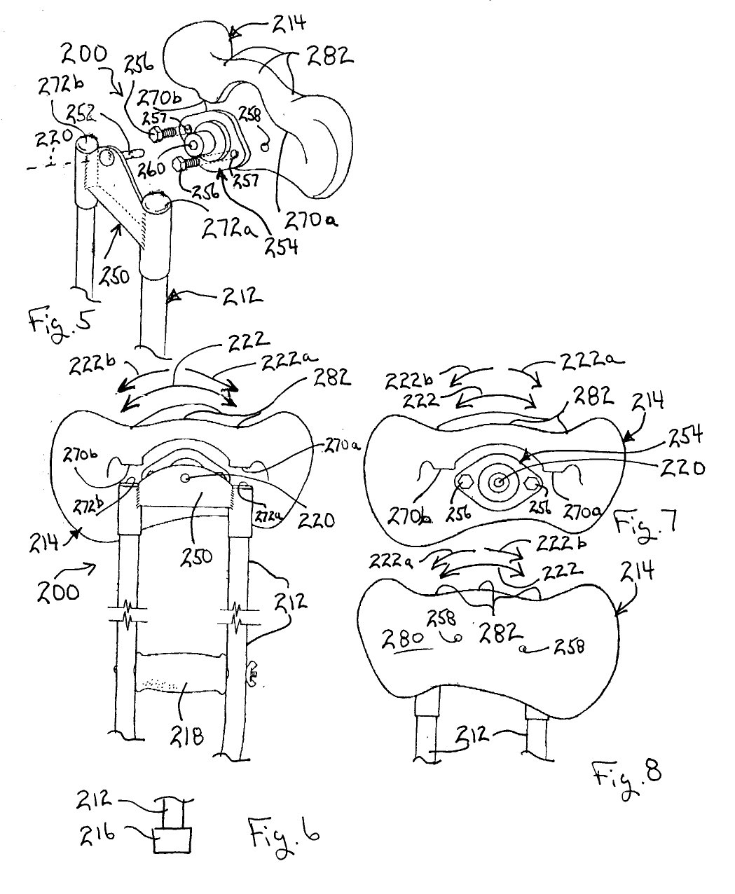

One example includes frame 12 being in a forward position relative to leg 30 as indicated in FIG. 2 and frame 12 being in a rearward position relative to leg 30 as indicated in FIG. 3. In other words, as this particular person walks along making use of appliance 10, leg 30 and frame 12 move relatively forward and rearward. Under such particular use, pivoting movement of head 14 relative to frame 12 reduces or eliminates relative movement between the user's underarm and head 14. Thus, head 22 rocks in a forward direction 22a when frame 12 is generally forward of a user (FIG. 3) and rocks in a rearward direction 22b when frame 12 is generally rearward of a user (FIG. 2). Given that head 14 serves a weight-bearing function, reducing relative movement between head 14 and a user's underarm significantly reduces discomfort associated with using appliance 10.

Thus, appliance 10 may be operated by gripping handgrip 18 and transferring body weight 24 at head 14, but appliance 10 offers reduced opportunity for discomfort by virtue of reduced or eliminated relative movement between the weight-bearing head 14 and the user's underarm. In other words, a user's weight 24 can be carried through pivot 20 without relative movement at a body-contacting location. The user thereby has opportunity to transfer a greater magnitude of body weight 24 into head 14 without suffering any associated discomfort due to relative movement between head 14 and, for example, the user's underarm.

Thus, in use a user may apply body weight 24, as indicated schematically at reference numeral 24, to aid in mobility. As the user moves along, distribution of weight 24 relative to head 14 varies and frame 12 moves in relation to the user's body generally. Pivoting movement of head 14 relative to frame 12 results. Head 14 generally does not, however, move relative to the user's underarm and surrounding body contact surfaces. As a result, appliance 10 can receive a greater magnitude body weight 24 with substantially less discomfort as compared to that associated with transferring body weight into a conventional crutch appliance.

The shape of head 14 can accommodate more closely, e.g., can be contoured to interfit, the user's body contour. Because head 14 need not move relative to the user's body, contouring of head 14 relative to the associated body contact surface better interlocks head 14 and the user's body contact surface to further reduce relative movement therebetween. Such contouring also aids in better distributing weight transfer and, therefore, improves comfort associated with applying body weight to head 14.

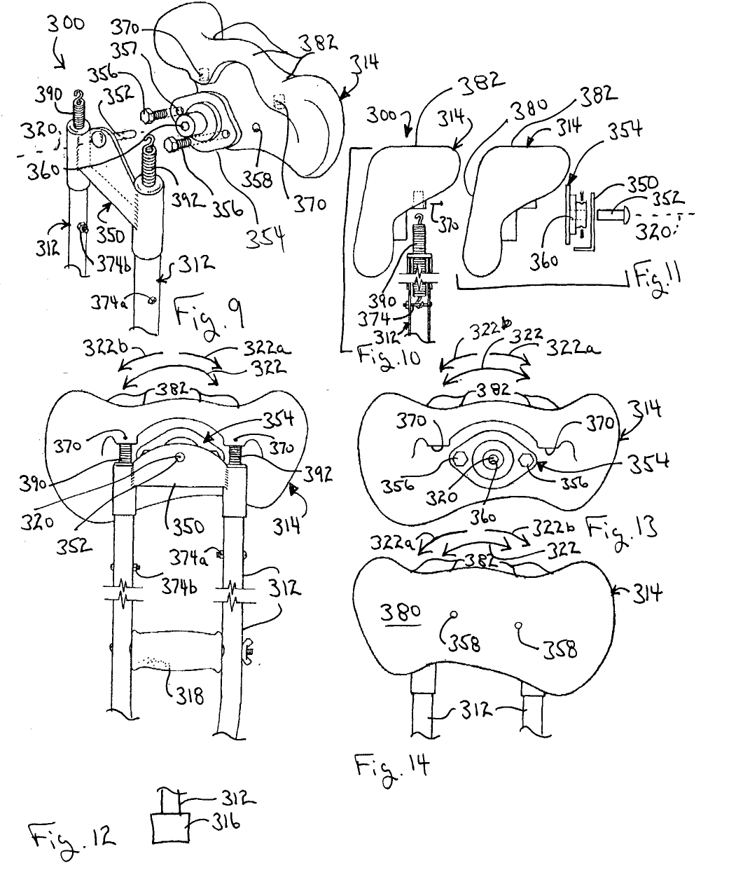

FIG. 4 illustrates a second embodiment of the present invention, a mobility apparatus 100 providing a crutch structure and crutch function. In FIG. 4, appliance 100 operates generally in the fashion of appliance 10 as described above and illustrated in FIGS. 1-3. Appliance 100 includes a head 114 pivotally mounted, e.g., along at laterally disposed pivot axis 120, relative to an upper portion of frame 112. Appliance 100 also includes a handgrip 118 and a peg 116.

Appliance 100 further includes biasing elements applying a biasing force 190 at a forward location relative to pivot axis 120 and a biasing force 192 at a rearward location relative to pivot axis 120. In this manner, head 114 enjoys rotation or pivoting as indicated at reference numeral 122 in forward and rearward directions 122a and 122b, respectively, but achieves a given “biased” position when under the exclusive influence of biasing forces 190 and 192. For example, biasing forces 190 and 192 can be downward-directed forces, e.g., by coupling in tension an elastic or spring element between head 14 and frame 112. As may be appreciated, elastic or spring elements need not be in tension at all times, but rather when appropriate to draw head 14 toward its “biased” position. Depending on the relative magnitude of forces 190 and 192, head 114 achieves a given biased position. For example, if biasing force 190 exceeds biasing force 192, head 114 assumes a generally rearward-inclined biased position by rotation along the rearward direction 122b. Similarly, if biasing force 192 exceeds biasing force 190, then head 114 assumes a generally forward-inclined biased position along the forward direction 122a.

A selected biased position can advantageously aid in use of appliance 100. A variety of mechanisms may be employed to establish, vary and/or maintain the overall magnitude and the relative magnitude of biasing forces 190 and 192. A biasing arrangement as illustrated in FIG. 4 also maintains stable head 114 relative to frame 112, but accommodates pivoting movement 122 as described herein in response to use of appliance 100, e.g., forces developed during use and transferred from a user's underarm to head 114.

In use, appliance 100 receives body weight 124. The orientation and distribution of weight 124 relative to head 114 varies as does the relative position of frame 112 and various portions of the user's body when the user moves along in use appliance 100. As a result, head 114 pivots relative to frame 112, but generally remains substantially stationary relative to a contact surface of the user's body, e.g., as in the case of head 114 engaging a user's underarm and surrounding surface s. The user thereby has opportunity to transfer a greater magnitude weight 124 without associated greater discomfort, and thereby improves mobility through use of appliance 100.

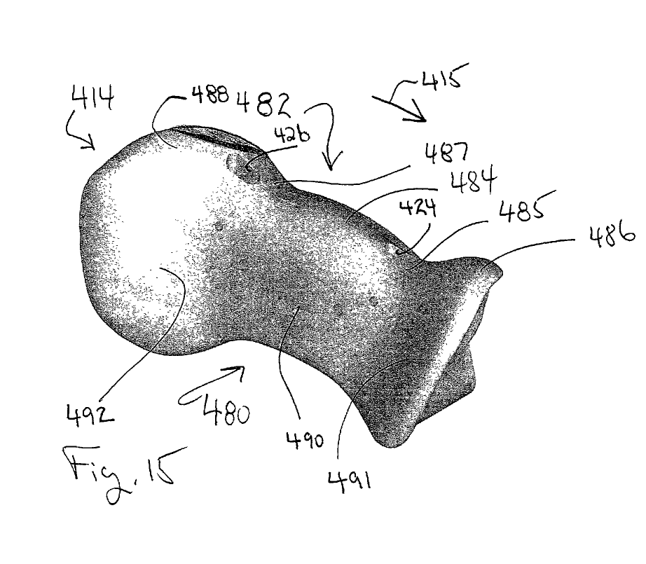

FIGS. 5-8 illustrate another embodiment of the present invention, an appliance 200 providing a crutch structure and function generally as discussed above with respect to appliance 10. Appliance 200 includes a frame 212. Appliance 200 also includes a ground-contacting peg 216 and a handgrip 218 coupled to frame 212. For example, ground-contacting peg 216 lies at a distal end of frame 212 and handgrip 218 lies along the length of frame 212.

Appliance 200 includes, at an upper or proximal portion of frame 212, a pivot brace plate 250. A laterally disposed pivot pin 252 lies perpendicular to plate 250 and extends laterally inward relative to frame 212 to define pivot axis 220. A flanged bearing 254 mounts to head 214 by way of bearing mount bolts 256 passing through apertures 257 of flanged bearing 254 and into threaded apertures 258 of head 214.

Pivot pin 252 extends into aperture 260 of flanged bearing 254 and thereby establishes a pivoting or rotatable load transfer relationship between frame 212 and head 214. In this manner, head 214 enjoys pivoting or rotating movement 222 along a forward direction 222b and a rearward direction 222a.

A pair of downward facing shelves 270 can be located near suitable portions of frame 212, e.g., upward-facing shelves 272, whereby downward-facing shelves 270 of head 214 move into abutting relationship with upward-facing shelves 272 to limit the extent of movement 222. Thus, downward-facing shelf 270a engages upward-facing shelf 272a when head 214 moves fully in its forward direction 222a. Similarly, downward-facing shelf 270b engages upward-facing shelf 272b when head 214 moves fully in its rearward direction 222b.

A generally inward-facing surface 280 (FIG. 8) of head 214 engages the generally laterally outward-facing body or torso contact surface of the user. A generally upward-facing surface 282 of head 214 is a weight-bearing surface whereat a user transfers body weight from body contact surfaces and into appliance 200.

Collectively, the inward-facing surface 280 and upward-facing surface 282 of head 214 present a contoured body-engaging element. More particularly, the overall size and contour of head 214, especially at surfaces 280 and 282, present a surface contour complementary relative to a user's underarm contact surface contour and torso contact surface contour. As a result, head 214 finds close and interfitting contact with the user's underarm and adjacent body region. This complementary inter-fit, or matingly-compatible relation, between surfaces 280 and 282 of head 214 and user's body contact surfaces make more stationary head 214 when engaging a user's body. Such contouring aids in better distributing transferred body weight as well as further aids in maintaining more stationary head 214 relative to the user's body. Overall, with better-distributed body weight and less relative movement, the user enjoys greater comfort with greater opportunity for improved mobility through use of appliance 200.

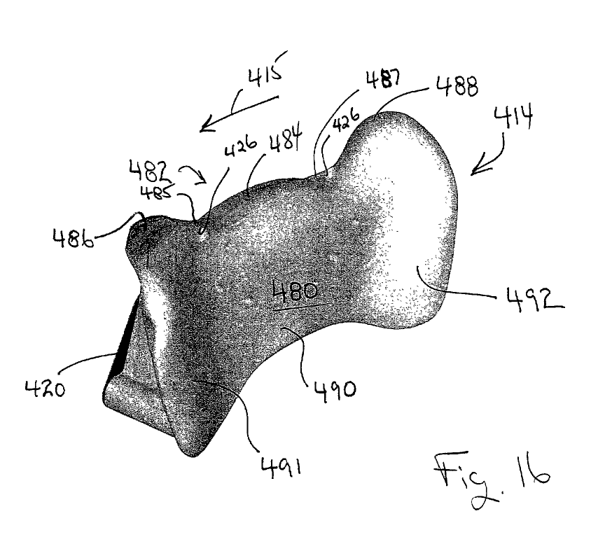

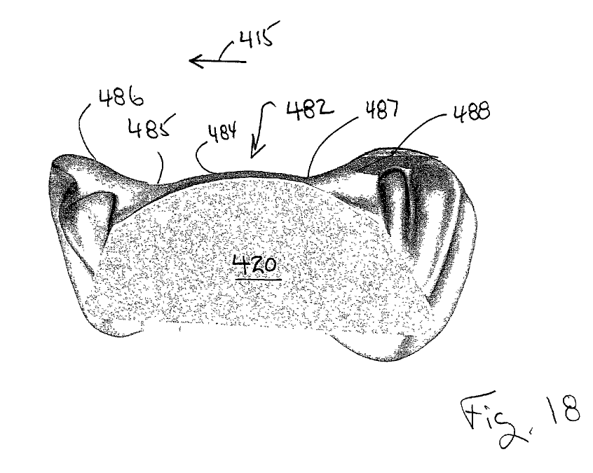

FIGS. 9-14 illustrate another embodiment of the present invention, an appliance 300 providing a crutch structure and crutch function. Appliance 300 finds similarity relative to appliance 200 in its frame 312, pivoting head 314, ground-contacting peg 316, and handgrip 318. Head 314 pivotably mounts relative to frame 312 by way of flanged bearing 354. More particularly, a plate 350 at an upper or proximal end of frame 312 carries a pivot pin 352 and flanged bearing 354 mounts to head 314 by way of bolts 356 through apertures 357 of bearing 354 and into threaded apertures 358 of head 314. Inserting pin 352 into bearing aperture 360 mounts head 314 rotatably in relation to frame 312. Head 314 thereby enjoys pivoting or rotational movement 322 relative to a laterally disposed pivot pin 352 including rotational movement in a rearward direction 322b and in a forward direction 322a about pivot axis 320.

Appliance 300 further includes a pair of biasing elements 390 and 392. As illustrated in the particular embodiment of appliance 300, biasing elements 390 and 392 are spring elements. It will be understood, however, that a variety of tensioned and tensionable or elastomeric or spring-like devices may be employed to provide a biasing function as described herein. Biasing element 390 draws head 314 toward its rearward direction 322b and biasing element 392 draws head 314 towards its forward direction 322a.

Head 314 includes suitable attachment points 370 corresponding to the upper portions, e.g., hooks, of the particular biasing elements 390 and 392 used. The opposite or lower end of biasing elements 390 and 392 couple at locator pins 374. With an upper portion of frame 312 presenting a tubular structure, biasing elements 390 and 392 may be positioned at such upper portion of frame 312 within such tubular structure. Locator pins 374 extend through such tubular elements and provide lower attachment points for biasing elements 390 and 392.

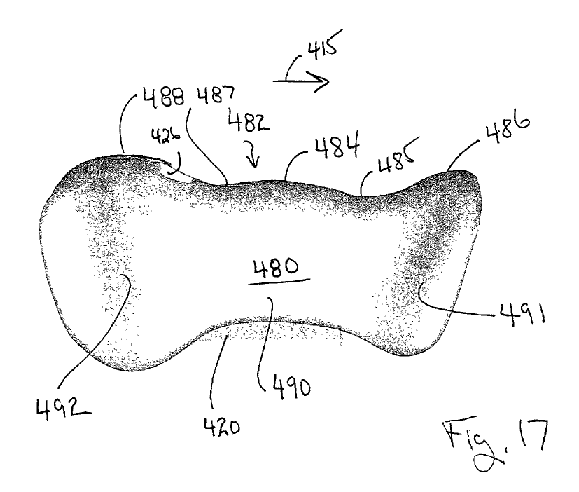

As best seen in FIG. 12, attachment pins 374 may be located at different relative distances from head 314 to achieve variation in biasing tension applied to head 314. Thus, when implemented as spring devices 390 and 392 as illustrated in this particular embodiment of the present invention, similar springs apply different magnitude biasing force. When implemented in other embodiments, e.g., such a elastomeric elements or other spring-like elements, variation in biasing element length can also establish variation in biasing force applied. In the particular embodiment illustrated in FIG. 12, forward pin 374a is slightly closer to head 314 than rearward pin 374b. Biasing element 390 thereby applies a greater biasing force relative to that of biasing element 392. As a result, head 314 can assume a slightly forward-oriented biased position, e.g., along the direction 322a. As may be appreciated, however, a variety of biased positions may be achieved by variation in relative tensioning and biasing forces applied to head 314.

Appliances 200 and 300 of FIGS. 5-14 are shown in a right-hand sense, i.e., adapted for use on the right side of the user's body. It will be understood that a left-hand sense form of appliances 200 and 300 (not shown) follows a suitable reflection in design for use on the left side of the user's body. Accordingly, the present invention further encompasses such forms of left-hand sense appliance. A pair of such appliances, e.g., one of right-hand sense and the other of left-hand sense, can be used concurrently, e.g., on right and left sides, respectively, of the user's body. Thus, together a right-hand sense crutch appliance and a left-hand sense crutch appliance make a pair of or a set of crutches.

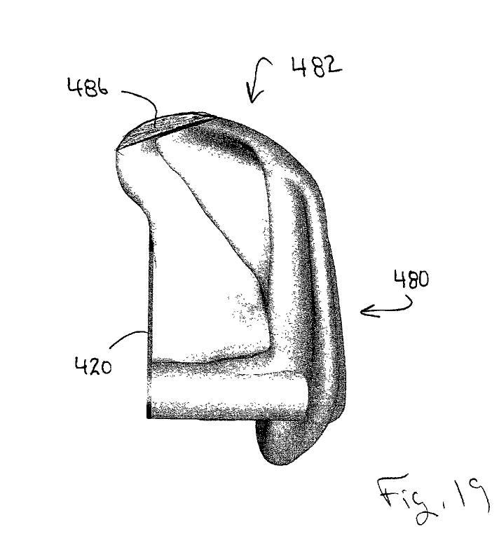

FIGS. 15 and 16 illustrate in perspective a particular embodiment of a head 414. Head 414 can be used as a pivotable crutch head, for example, in the various embodiments of the present invention as described and as shown herein. As such head 414 finds utility in a pivotal relationship with a supporting frame structure and thereby promotes improved function and comfort of mobility appliance use. FIGS. 17, 18, 19, and 20 illustrate right, left, front and back views, respectively, of head 414.

In FIGS. 15-20, head 414 includes generally laterally-inward facing surface area 480 and includes a generally upward-facing surface area 482. Each of areas 480 and 482 include surface contouring generally complimentary in relation to, e.g., substantially inter-fitting with, contact surface contouring of the user's body, e.g., at the intended body contact surfaces thereof.

The contoured nature of the head 414 thereby accommodates or inter-fits with body features to reduce slipping and relative movement. In combination with the pivoting action, this encourages interface or coupling between the appliance head and the user's body. In prior crutch appliances such inter-fit or intentional engagement between the head and the person's body is undesirable because these elements have significant relative rotation during use. Under the illustrated embodiments of the present invention, however, such significant relative movement need not exist and interlocking or inter-fitting the head contour with the user's body contour promotes reduced relative movement therebetween in furtherance of improved comfort of use. For example, the user's body can be more widely distributed, thereby serving greater comfort of use.

Thus, rotation of the body contacting element, e.g., head 414, in relation to the frame, e.g., frames 12,112,212, and 312, is influenced predominately by the position of user's body in relation to the appliance generally. As such, appliance heads as proposed under various embodiments of the present invention, better track, e.g., move along with, the user's body contact surfaces and thereby substantially improve both comfort and function.

Surface area 482 includes a generally centrally located mound 484. Mound 484 is generally complimentary in contour relative to a user's central underarm area, e.g., fits into the user' armpit. Moving in a forward direction 415 along surface area 482, mound 484 transitions into a valley 485. Continuing forward along surface area 482, valley 485 transitions into upward rise 486. Similarly, but rearward along surface 482, mound 484 transitions into valley 487. Continuing rearward along surface area 482, valley 487 transitions into mound 488.

Surface area 480 includes a generally centrally located surface 490 facing generally laterally inward. Surface 490 is generally planar and is generally wider in its upper portion relative to its lower portion. Moving forward along surface area 480, surface 490 makes transition into surface 491. Surface 491 is generally planar but faces generally laterally inward and rearward and slopes generally upward and generally forward from its lower portion to its upper portion. Moving rearward along surface area 480, surface 490 makes transition into surface 492. Surface 492 is generally planar but faces generally laterally inward and forward and slopes generally upward and generally rearward from its lower portion to its upper portion. Overall, surface area 480 corresponds to a vertically disposed and shallow valley of diminishing cross sectional area from its upper portion to its lower portion.

Generally, mound 484 engages a user at the underarm armpit contact surface. Valleys 485 and 487 contact and accommodate underarm contact surfaces forward and rearward, respectively, in relation to the user's engagement at mound 484. A laterally inward-facing torso contact surface just below the underarm of the user engages surface 490. A laterally outward-facing and forward-facing torso contact surface just below and forward the user's underarm engages surface 491. A laterally outward-facing and rearward-facing torso contact surface just below and rearward of the user's underarm engages surface 492.

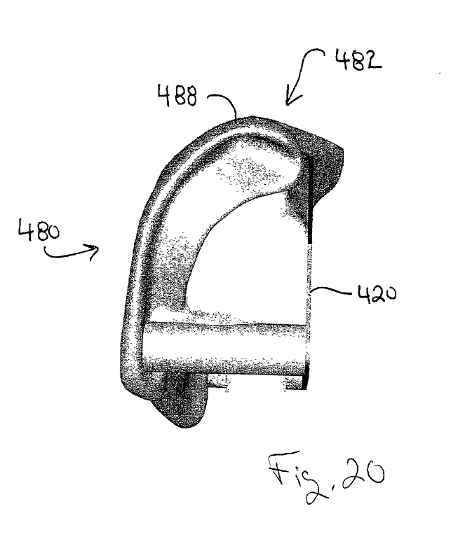

As best seen in FIGS. 18-20, head 414 includes a cover plate 420 presenting an exterior portion of head 414 exposed to the user's inner arm just below the underarm. Plate 420 encloses or covers various components of head 414 when implemented as a pivoting crutch appliance, e.g., as a body-contacting crutch appliance head such as heads 14, 114, 214, and 314 as illustrated herein. For example, plate 420 can cover internal components corresponding to plates 250 and 350, pivot pins 252 and 352, flange bearings 254 and 354, biasing elements such as 390 and 392. In this way, such interior components are not exposed and do not undesirably engage, contact, or otherwise rub against and thereby discomfort a user.

In the particular form of head 414 illustrated in FIGS. 15-20, a variety of biasing elements may be used. Head 414 includes vertically disposed apertures 424 and 426 providing mounting sites for upper ends of biasing elements (no shown). For example, elastomeric, e.g., bungee cord material may be used as biasing elements with the upper ends located near upper openings of apertures 424 and 426. Shelves (not shown), for example, along apertures 424 and 426 and near the upper openings thereof block biasing element upper ends against movement downward and along apertures 424 and 426. A plug or other padding may be used to then plug or otherwise cover the upper ends of apertures 424 and 426. As may be appreciated, the lower ends of the biasing elements can be coupled to a crutch frame (not shown) generally as described herein.

Head 414 FIGS. 15-20 is shown in a left-hand sense, i.e., adapted for use on the left side of the user's body. It will be understood that a right-hand sense form of head 414 (not shown) follows a suitable reflection in design for use on the right side of the user's body. Accordingly, the present invention further encompasses such forms of right-hand sense head 414. A pair of such heads, e.g., one of right-hand sense and the other of left-hand sense, can be used concurrently, e.g., on right and left sides, respectively, of the user's body. Thus, together a crutch appliance with right-hand sense head 414 and a crutch appliance with a left-hand sense head 414 work cooperatively in a pair or set of crutch appliances used concurrently.

Thus, an improved mobility appliance has been shown and described. A weight-bearing portion of an appliance as described according to embodiments herein enjoys a pivotal relationship to a remaining portion of the appliance. Body weight as applied to the weight-bearing portion of the appliance transfers without an associated significant relative movement between the user's body and the weight-bearing portion of the appliance. Improved user comfort results.

Placing a head pivot axis by a common pivot pin at or near the upper or proximal end of the crutch frame keeps the pivot axis near the user and maintains a reduced radius for rotational or pivoting movement relative to the frame. The crutch head enjoys pivotal movement independent of frame orientation, and thereby better tracks user movements, e.g., can move with the user at body contacting surfaces and is not restricted in orientation as a function of frame 12 orientation. The frame can be a simple rigid or static structure, no moving parts or mechanical features, and manufactured at relatively low cost. Accordingly, frame 12 advantageously can be simple, but highly reliable as compared to articulated or mechanically complex appliance structures.

When the head mounts in cantilevered relation to the frame, e.g., hangs at or near a laterally inward end of the pivot pin, a user of an appliance under embodiments of the present invention has greater separation between himself or herself, but enjoys stable comfortable support, e.g., in aid of mobility, therefrom. In many prior crutch appliances, a head typically mounts directly above the frame, thereby bringing the frame closer to the user during use thereof. According to certain aspects of embodiments of the present invention, however, a space between the user and the frame, e.g., as by mounting the head in cantilevered fashion, promotes less opportunity for the frame to rub against or bump into the user. The frame is relatively more easily moved relative to the user's body and without impediment therefrom. Improved function results. Further, the user experiences less discomfort in use thereof. Improved comfort of use results.

Thus, the illustrated embodiments of the present invention reduce rubbing and chafing often experienced by conventional crutch apparatus. The contoured head design holds securely to the upper body while the pivot action reduces the motion of the appliance while walking. Tension springs or other suitable tensioning elements smooth and control pivoting in a comfortable fashion. Significant reduction of rubbing under ones arms, less stress on arms and hands from lifting the upper body away from the crutch head and other comfort-related benefits derive from various embodiments of the present invention as illustrated herein.

It will be appreciated that the present invention is not restricted to the particular embodiment that has been described and illustrated, and that variations may be made therein without departing from the scope of the invention as found in the appended claims and equivalents thereof.

What is claimed is:

1. A mobility appliance comprising:
a support structure having a proximal end and a distal end, said distal end carrying a ground-contacting peg; and
a weight-bearing body contact element, said body contact element rotating about a pivot axis at said proximal end.

2. A mobility appliance according to claim 1 wherein said contact element comprises surface contouring complementary to a contact surface contouring of a user of said appliance.

3. A mobility appliance according to claim 1 wherein said contact element rotates about a single axis of rotation.

4. A mobility appliance according to claim 3 wherein said single axis of rotation is proximate an underarm contact surface of a user when using said appliance.

5. A mobility appliance according to claim 1 wherein said support structure is a ridge frame structure and said peg pivots in contact with and against a ground surface in use of said mobility appliance.

6. A mobility appliance according to claim 1 further comprising a pivot pin pivotally coupling said support structure and said contact element.

7. A mobility appliance according to claim 1 wherein an orientation of a pivot axis for said contact element is a lateral orientation.

8. A mobility appliance according to claim 1 further comprising at least two biasing elements coupling said contact element and said support structure.

9. A mobility appliance according to claim 8 wherein said at least two biasing elements apply corresponding at least two biasing forces assuming a generally common direction, said pivot axis being interposed therebetween.

10. A mobility appliance according to claim 9 wherein said at least two biasing forces vary in relative magnitude of force along said generally common direction.

11. A mobility appliance according to claim 1 wherein said support structure is a static rigid structure.

12. A mobility appliance according to claim 1 wherein said contact element mounts in cantilevered relation to said support structure by way of said pivot pin.

13. A crutch appliance comprising:
a frame having an upper end and a lower end;
a ground-contacting peg affixed at a lower end of said frame;
a head positioned at said upper end of said frame; and
a pivot pin pivotally coupling said upper end of said frame and said head, said head rotating about a pivot axis coincident with said pivot pin.

14. A mobility appliance according to claim 13 wherein said head comprises a body-contacting, weight-bearing element of said crutch appliance when said crutch appliance is used by placing said head at an underarm of a user and by transferring weight into said crutch at said head and from said crutch at said ground-contacting peg.

15. A mobility appliance according to claim 15 wherein said head comprises surface contouring complementary to a contact surface contouring of a user of said appliance, and wherein said head rotates about a single axis of rotation proximate an underarm contact surface of a user when using said appliance

16. A method of assisting mobility comprising:
locating a body-contacting weight-bearing appliance element at an underarm of a user;
allowing relative rotation of said appliance element in relation to a rigid frame element while transferring user body weight from said appliance element to said frame; and
providing a ground-contacting element at a lower end of said frame.

17. A method of assisting mobility according to claim 16 wherein said relative rotation results from said appliance element following said underarm of said user.

18. A method of assisting mobility according to claim 16 further comprising:
transferring said body weight to a ground surface by way of said ground contacting element.

19. A method of assisting mobility according to claim 16 further comprising:
moving said frame relative to said user while maintaining substantially stationary said appliance element relative to said underarm of said user.

20. A method of assisting mobility according to claim 16 further comprising:
transferring weight of said user at said appliance element while pivoting said appliance element in relation to said frame.
